(19) United States
(12) Patent Application Publication
(10) Pub. No.: US 2014/0318523 A1
(43) Pub. Date: Oct. 30, 2014

(54) METHOD OF MAKING A GLASS FORMING APPARATUS WITH REDUCED WEIGHT

(71) Applicant: CORNING INCORPORATED, Corning, NY (US)

(72) Inventor: Paul Maynard Schermerhorn, Painted Post, NY (US)

(73) Assignee: Corning Incorporated, Corning, NY (US)

(21) Appl. No.: 13/872,342

(22) Filed: Apr. 29, 2013

(51) Int. Cl. B28D 1/02; B28D 1/08; B28D 1/06

(52) U.S. Cl. CPC B28D 1/02; B28D 1/06; B28D 1/08
USPC 125/19; 125/12; 125/21

(57) ABSTRACT

A method of making a glass forming apparatus with reduced weight includes forming a cavity in the glass forming apparatus and expanding the size of the cavity by abrasively removing material from the glass forming apparatus through application of a wire saw.

### FIELD

This invention relates to isopipes used in the production of sheet glass by the fusion process and, in particular, to methods of making a glass forming apparatus with reduced weight.

### BACKGROUND

Manufacturers of flat panel displays, such as, liquid crystal displays (LCDs), use glass substrates to produce multiple displays simultaneously, e.g., six or more displays at one time. The width of a substrate limits the number of displays that can be produced on a single substrate, and thus wider substrates correspond to increased economies of scale. Also, display manufacturers need wider substrates to satisfy a growing demand for larger size displays.

In addition, such manufacturers are seeking glass substrates that can be used with polycrystalline silicon devices that are processed at higher temperatures. In particular, a need exists for high strain point glass compositions that do not undergo compaction during display manufacture. Such glasses generally require higher forming temperatures, and thus a need exists for glass forming processes that can withstand such higher temperatures.

The fusion process is one of the basic techniques used in the glass making art to produce sheet glass. Compared to other processes known in the art, e.g., the float and slot draw processes, the fusion process produces glass sheets whose surfaces have superior flatness and smoothness. As a result, the fusion process has become of particular importance in the production of the glass substrates used in the manufacture of liquid crystal displays (LCDs).

The fusion process, specifically, the overflow downdraw fusion process, is the subject of commonly assigned U.S. Pat. Nos. 3,338,696 and 3,682,609, to Stuart M. Dockerty, the contents of which are incorporated herein by reference. A schematic drawing of the process of these patents is shown In FIG. 1. As illustrated therein, the system includes a supply pipe 9 which provides molten glass to a collection trough 11 formed in isopipe 13.

Once steady state operation has been achieved, molten glass passes from the supply pipe to the trough and then overflows the top of the trough on both sides, thus forming two ribbons of glass that flow downward and then inward along the outer surfaces of the isopipe. The two ribbons meet at the bottom or root 15 of the isopipe, where they fuse together into a single ribbon. The single ribbon is then fed to drawing equipment (represented schematically by arrows 17), which controls the thickness of the ribbon and thus the ultimate sheets by the rate at which the ribbon is drawn away from the root.

As can be seen in FIG. 1, the outer surfaces of the final glass ribbon do not contact any part of the outside surface of the isopipe during any part of the process. Rather, these surfaces only see the ambient atmosphere. The inner surfaces of the two half ribbons which form the final ribbon do contact the isopipe, but those inner surfaces fuse together at the root of the isopipe and are thus buried in the body of the final ribbon. In this way, the superior properties of the outer surfaces of the final glass sheets cut from the ribbon are achieved.

As is evident from the foregoing, isopipe 13 is critical to the success of the fusion process. In particular, the dimensional stability of the isopipe is of great importance since changes in isopipe geometry affect the overall success of the process. Significantly, the conditions under which the isopipe is used make it susceptible to dimensional changes. The isopipe typically operates at elevated temperatures on the order of 1000° C. and above. Moreover, the isopipe operates at these elevated temperatures while supporting its own weight as well as the weight of the molten glass overflowing its sides and in trough 11, and at least some tensional force that is transferred back to the isopipe through the fused glass as it is being drawn. Depending on the width of the glass sheets that are to be produced, the isopipe can have an unsupported length of 2.0 meters or more.

To withstand these demanding conditions, isopipes 13 have been manufactured from isostatically pressed blocks of refractory material (hence the name “iso-pipe”). In particular, isostatically pressed zircon refractories have been used to form isopipes for the fusion process.

Even with such high performance materials, in practice, isopipes exhibit dimensional changes which limit their useful life. For example, at elevated temperatures, ceramic materials undergo creep and isopipes exhibit sag, particularly along their middle, and other dimensional changes. These dimensional changes occur both along the root of the isopipe and along the weirs at the top of the pipe.

In view of the foregoing, it can be seen that a need exists for apparatus and methods which will allow the fusion process to be used effectively and economically to produce glass sheets which have larger widths and/or are composed of glasses having higher strain points. In particular, a need exists to improve the dimensional stability of isopipes and thereby extend their service life and thus minimize process down time and isopipe replacement costs.

### SUMMARY

Disclosed herein is a method for reducing the weight of a glass forming apparatus. The glass forming apparatus includes a trough extending along a longitudinal length of the glass forming apparatus from a first end to a second end, the trough having a bottom surface. The glass forming apparatus also includes a first weir and a second weir longitudinally extending along a first and second side of the trough, the first and second weirs having upper surfaces and the first and second weirs converging at a distance away from the trough to form a wedge-shaped root. The distance between the upper surfaces of the first and second weirs and the bottom surface of the trough decreases between the first end and the second end. The method includes forming at least one cavity between the bottom surface of the trough and the wedge-shaped root, the cavity extending along a longitudinal length of the glass forming apparatus from the first end to the second end. In addition, the method includes expanding the size of the cavity by abrasively removing material from the glass forming apparatus through application of a wire saw.

It is to be understood that both the foregoing general description and the following detailed description are merely exemplary of the invention and are intended to provide an overview or framework for understanding the nature and character of the invention.

Additional features and advantages of the invention are set forth in the detailed description which follows, and in part will be readily apparent to those skilled in the art from that description or recognized by practicing the invention as described herein. The accompanying drawings are included to provide a further understanding of the invention, and are incorporated in and constitute a part of this specification. It is to be understood that the various features of the invention disclosed in this specification and in the drawings can be used in any and all combinations.

### BRIEF DESCRIPTION OF THE DRAWINGS

FIG. 1 is a perspective, schematic drawing illustrating a representative construction for an apparatus for use in an overflow downdraw fusion process for making flat glass sheets;

FIG. 2 is a perspective, schematic drawing illustrating a representative construction of an embodiment disclosed herein, the embodiment having a trough and a wedge-shaped root and having a cavity formed between the bottom surface of the trough and the wedge-shaped root;

FIG. 3 is a schematic, cross-sectional drawing illustrating a representative construction of an embodiment disclosed herein, the embodiment having a trough and a wedge-shaped root and having a cavity formed between the bottom surface of the trough and the wedge-shaped root;

FIG. 4 is a perspective, schematic drawing illustrating a representative construction of an embodiment disclosed herein, the embodiment having an expanded cavity relative to the embodiment shown in FIGS. 2 and 3;

FIG. 5 is a perspective, schematic drawing illustrating a representative construction of an embodiment disclosed herein, the embodiment having an expanded cavity relative to the embodiment shown in FIG. 4;

FIG. 6 is a perspective, schematic drawing illustrating a representative construction of an embodiment disclosed herein, the embodiment having an expanded cavity relative to the embodiment shown in FIG. 5;

FIG. 7 is a perspective, schematic drawing illustrating a representative construction of an embodiment disclosed herein, the embodiment having a trough and a wedge-shaped root and having two expanded cavities formed between the bottom surface of the trough and the wedge-shaped root;

FIG. 8 is a perspective, cross-sectional drawing illustrating a representative construction of an embodiment disclosed herein, the embodiment having two expanded cavities, each containing heat transfer facilitation elements;

FIG. 9 is a side perspective drawing illustrating a representative construction of an embodiment disclosed herein, the embodiment having a trough and a cavity extending along a longitudinal axis that is generally parallel to the bottom surface of the trough; and

FIG. 10 is a side perspective drawing illustrating a representative construction of an embodiment disclosed herein, the embodiment, having a first end and a second end and a cavity extending from the first end to the second end, wherein the cavity has a tapered inner area such that the area of the cavity is greater at the second end than at the first end.

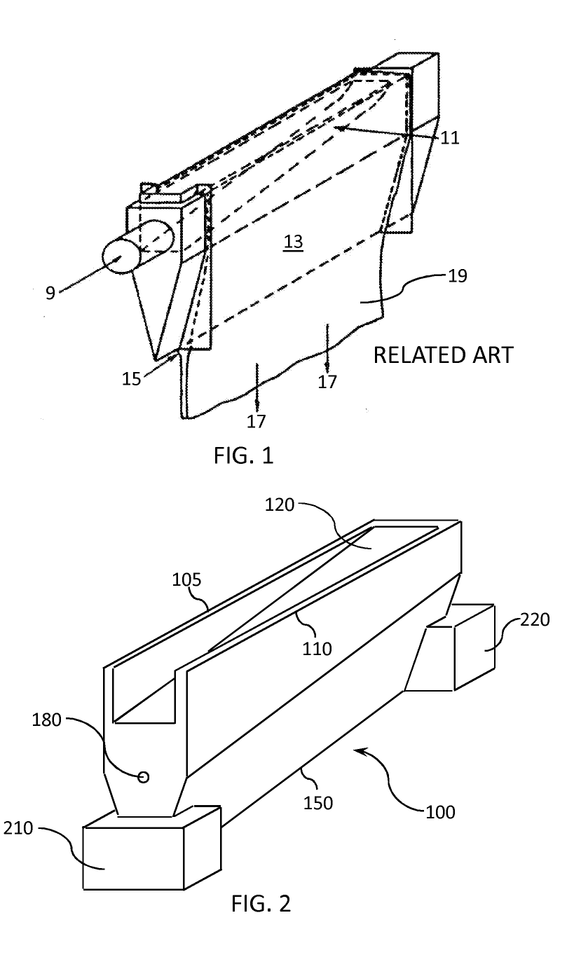

### DETAILED DESCRIPTION OF THE PREFERRED EMBODIMENTS

As discussed above, methods for producing LCD substrates include using the fusion process in which molten glass is formed into a ribbon by being passed over a large ceramic structure known as an isopipe. Over time, LCD substrates have increased in size to greater than 2800 millimeters×3000 millimeters. Each increase in size has meant a corresponding increase in isopipe length.

This migration to larger isopipes has placed significant challenges on the ability of isopipes to have multi-year useful lives. For exemplary glass compositions, the weirs of the isopipe typically operate at a temperatures above 1200° C. while the root operates at temperatures above 1100° C. This high temperature condition causes the isopipe's refractory material, e.g., zircon, to undergo creep. As a general rule, the larger the isopipe size, the more creep will be generated.

Stress analysis shows that as a first approximation, the absolute deflection (D) of an isopipe depends on the intrinsic rate of creep (\dot{ε}=dε/dt) of the material from which the isopipe is made (units of 1/hr), as well as the time (t) the isopipe is in service and the isopipe's length (L) and height (H):

D≈k·\dot{ε}·L⁴/H²·t

As can be seen from this equation, doubling the length of the isopipe increases the deflection 16 fold for the same isopipe material, height, and time in use.

This increase in deflection can potentially be addressed by increasing the isopipe height. However, isopipe height is already near the fundamental limits for the isopress equipment currently available in the industry. Another alternative is to improve the compressive forces which are applied to the sides of the isopipe to combat creep (see commonly assigned US Patent Publication No. 2003/0192349), but this approach can place significant constraints on isopipe design that may result in glass flows below desired targets. Lowering the overall operating temperature is another possibility but it would require the development of new glass compositions capable of being processed at the lower temperatures. Finally, the creep rate of the ceramic material used to produce the isopipe can be reduced through the development of improved materials (see commonly assigned PCT Patent Publication No. WO 2002/044102). However, even in this case, future substrate sizes and isopipe designs may continue to push the ceramic materials into areas that are not capable of achieving sufficiently long usable lives.

Various proposals have been made to reduce the sag of isopipes through the use of support rods and holes in the body of the isopipe. See U.S. Pat. No. 3,437,470; Japanese Patent Publication No. 11-246230; Japanese Patent Publication No. 2006-298736; Japanese Patent Publication No. 2006-321708; and Japanese Patent Publication No. 2007-197303. Significantly, none of these references has enabled a means to carefully control the size and geometry of the holes in an efficient and cost-effective manner.

The typical process for manufacturing ceramic blanks for an isopipe is a multiple step process. For example, batch materials of zircon or other ceramic materials along with a binder can be prepared by, for example, spray drying. The batch materials can then be placed in a flexible bag and vibrated to allow particle settling and to achieve initial compaction. The bag can then be hermetically sealed and placed in an cold isostatic press to more fully compact the structure. The compacted structure can then be fired to a dense ceramic at high temperature.

According to embodiments disclosed herein, the dense ceramic can have a specific geometry that facilitates its use as a glass forming apparatus. As shown in FIG. 2, the glass forming apparatus 100 includes a trough 120 having a bottom surface extending along a longitudinal length of the glass forming apparatus from a first end to a second end. A first weir 105 and a second weir 110 longitudinally extend along a first and second side of the trough 120. The first and second weirs 105, 110 have upper surfaces and converge at a distance away from (or below) the trough to form a wedge-shaped root 150. The distance between the upper surfaces of the first and second weirs 105, 110 and the bottom surface of the trough 120 decreases between the first end and the second end. First end of glass forming apparatus 100 is seated with a first pier block 210 and second end of glass forming apparatus is seated with a second pier block 220. Pier blocks 210, 220 provide compression forces to mitigate sag of the glass forming apparatus.

As shown in FIG. 2, a cavity 180 is formed between the bottom surface of the trough 120 and the wedge-shaped root 150. Cavity 180 extends along a longitudinal length of the glass forming apparatus from the first end to the second end. Cavity 180 can be formed by drilling a hole along a longitudinal length of the glass forming apparatus from the first end to the second end. Cavity 180 or hole can also be formed during the initial ceramic blank manufacturing process. The cavity or hole can have, for example, a diameter of at least 0.5 centimeters, such as from 0.5 centimeters to 2 centimeters.

Once cavity 180 has been formed, the size of the cavity can be expanded by abrasively removing material from the glass forming apparatus through application of a wire saw. The wire saw can be, for example, a continuous loop wire saw having, for example, a continuous loop of wire that is welded together. Alternatively, the wire saw can be an oscillating or reciprocating wire saw.

The wire saw preferably comprises an abrasive material that is harder than the predominant material, e.g., zircon, of the glass forming apparatus. For example, the wire saw can include at least one abrasive material selected from the group consisting of diamond, silicon carbide, boron carbide, zirconium carbide, titanium diboride, titanium carbide, rhenium diboride, and boron nitride. In a preferred exemplary embodiment, the wire saw comprises diamond. The abrasive material may be fixed or loose.

Wire saw can be cooled with an aqueous or oil based coolant (e.g., water or oil) according to methods known to persons having ordinary skill in the art.

The motion of the wire saw can be controlled manually and/or by a computer, such as a Computer Numerical Control (CNC) machine. In preferred embodiments, the motion of the wire saw is controlled by a computer for X, Y and Theta motion control.

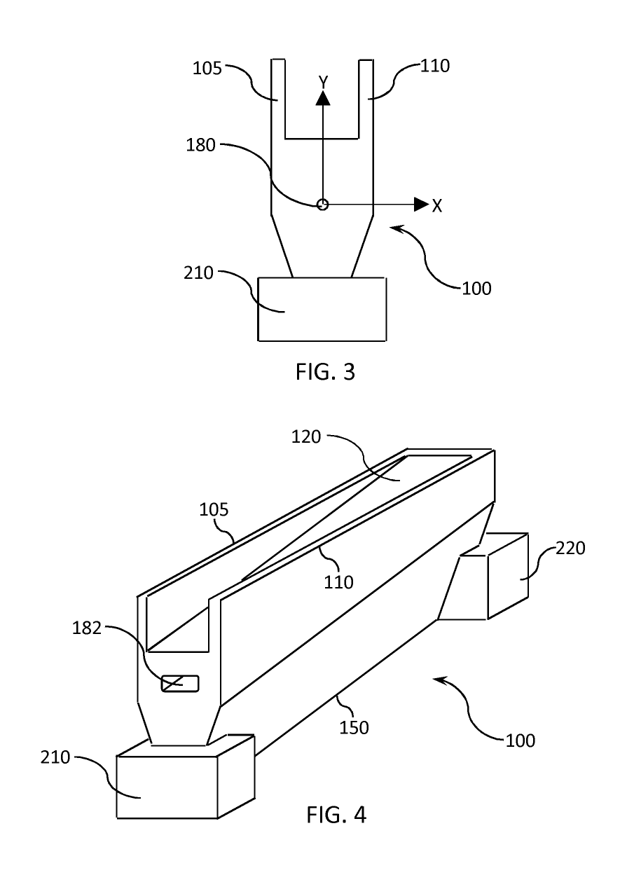

As shown in FIG. 3, the motion of the wire saw can be controlled so as to abrasively remove a predetermined amount of material from the glass forming apparatus in the X-direction (as indicated by arrow X) and in the Y-direction (as indicated by arrow Y) relative to the cavity 180 when viewed from the first end. For example, when controlled by a computer, the computer can be programmed to control the wire saw to remove a predetermined amount of material in the X-direction and in the Y-direction relative to the cavity 180 when viewed from the first end. This can allow for the cavity to have a shape (or interior space characteristic) that precisely conforms to a nearly limitless number of predetermined, three-dimensional, configurations.

For example, FIG. 4 illustrates an embodiment wherein the wire saw has been controlled to expand the size of the cavity illustrated in FIGS. 2 and 3. In the embodiment shown in FIG. 4, cavity 182 has been expanded more in the X direction than in the Y direction, such that cavity has a greater dimension in the X direction than in the Y direction. For example, the cavity can have a dimension in the X direction that is at least twice its dimension in the Y direction, such as a dimension in the X direction of at least 5 centimeters, such as from 5 centimeters to 10 centimeters wherein the dimension in the Y direction is no more than half the dimension in the X direction. Alternatively (not shown in FIG. 4), the wire saw can be controlled to expand the cavity more in the Y direction than in the X direction or to expand the size of the cavity approximately the same amount in both the X and the Y directions.

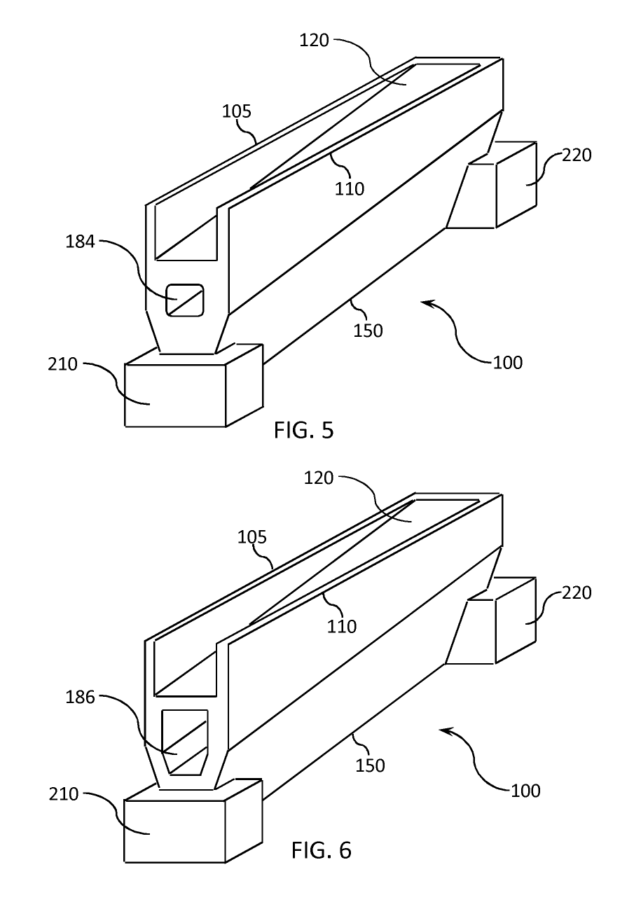

FIG. 5 illustrates an embodiment wherein the wire saw has been controlled to expand the size of the cavity to a larger size than in FIG. 4. In the embodiment shown in FIG. 5, cavity 184 has been expanded more in the Y direction than in the embodiment shown in FIG. 4. For example, the cavity can be expanded such that it has a dimension in the X and Y directions of at least 5 centimeters, such as from 5 centimeters to 10 centimeters.

FIG. 6 illustrates an embodiment wherein the wire saw has been controlled to expand the size of the cavity to a larger size than in FIG. 5. In the embodiment shown in FIG. 6, cavity 186 has been expanded such that it has a six sided configuration, wherein the top and bottom sides are generally parallel to each other, the upper right and left sides are generally parallel to each other (and perpendicular to the top and bottom sides) and the lower right and left sides are angled inward relative to the upper right and left sides, such that the lower right and left sides are generally parallel to either side of the wedge-shaped root. For example, the cavity can be expanded such that it has a direction in the X and Y directions of at least 10 centimeters, such as from 10 centimeters to 20 centimeters.

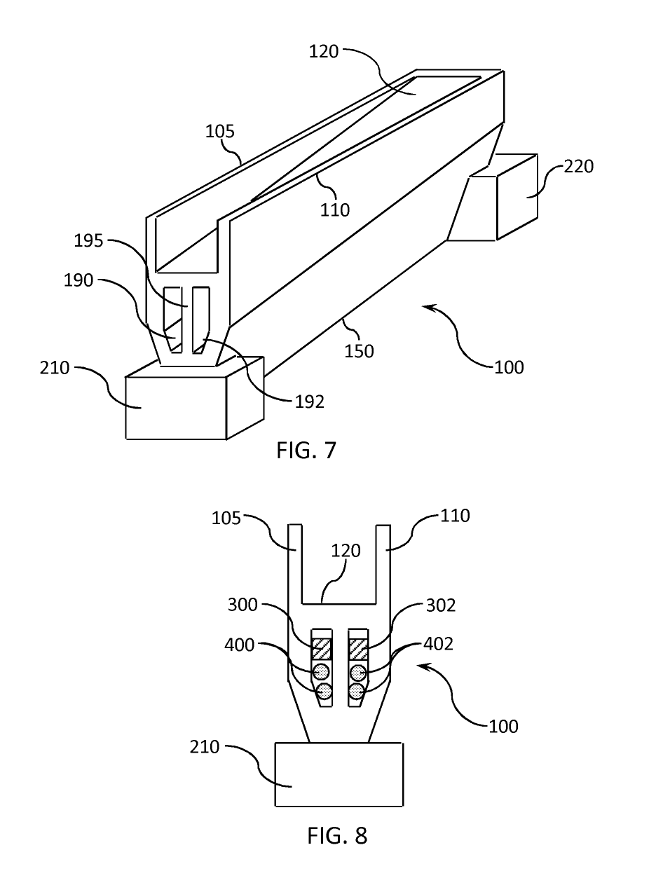

FIG. 7 illustrates an embodiment wherein at least two cavities 190 and 192 are formed and expanded through application of a wire saw between the bottom surface of the trough 120 and the wedge-shaped root 150 and extend along a longitudinal length of the glass forming apparatus from the first end to the second end. In the embodiment shown in FIG. 7, partition or web 195 is maintained between cavities 190, 192 following application of the wire saw. Partition or web 195 can contribute the rigidity of the structure and thereby mitigate the sag rate. The thickness of the partition or web 195, while not limited, can range from 2 centimeters to 15 centimeters, such as from 5 centimeters to 10 centimeters.

As a result of expanding the size of the cavity by abrasively removing material from the glass forming apparatus through application of a wire saw, the weight of the glass forming apparatus can be reduced by at least 15%, such as at least 20%, and further such as at least 25%, and yet further such as at least 30%, and still yet further such as at least 35%, such as from 15% to 45%, including from 20% to 40% and further including from 25% to 35%. For example, the overall weight of the glass forming apparatus can be reduced by at least 1,000 pounds, such as at least 2,000 pounds, and further such as at least 3,000 pounds, including from 1,000 to 4,000 pounds, and further including from 1,500 to 3,500 pounds, and still further including from 2,000 to 3,000 pounds.

Embodiments herein include those in which the cavity is expanded in one or more of any number of cross-sectional configurations including, for example, one or more configurations selected from the group consisting of square, rectangular, triangular, trapezoidal, pentagonal, hexagonal, heptagonal, octagonal, circular, and elliptical. Such configurations can be obtained by applying a wire saw to remove a predetermined amount of material in the X-direction and in the Y-direction, such as when the motion of the wire saw is controlled by a computer.

Application of a wire saw can not only result expand the size of a cavity in the X-Y direction as shown in FIG. 3, but can also enable various geometries along the longitudinal length of the glass forming apparatus. For example, in certain exemplary embodiments, the cavity may extend along a longitudinal axis that is generally parallel to the bottom surface of the trough. In such embodiments where the bottom surface of the trough is substantially level or horizontal, the cavity can extend along a longitudinal axis that is also generally level or horizontal.

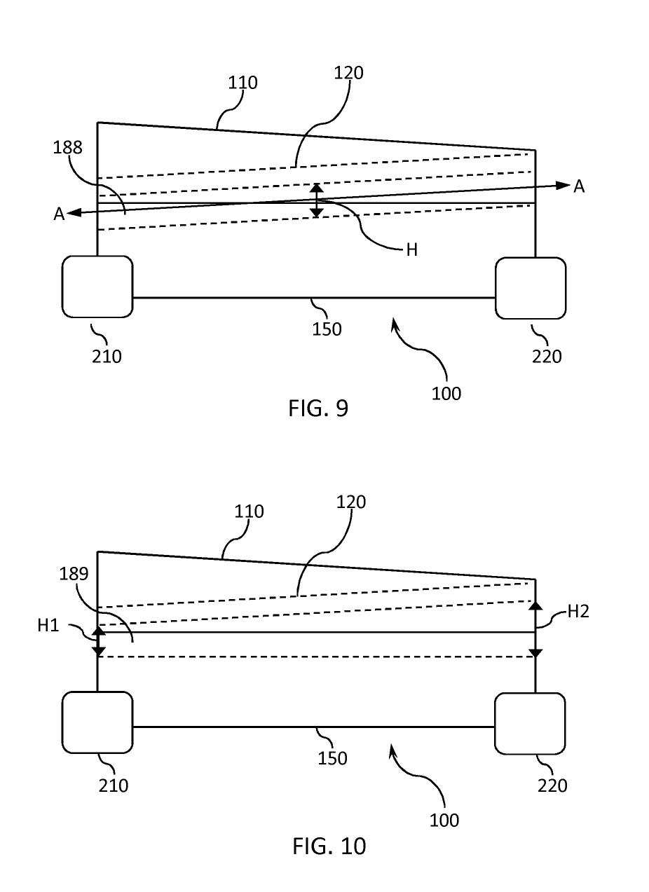

In embodiments where the bottom surface of the trough 120 is sloped such that it is lower on the first end than on the second end, as is shown in FIG. 9, cavity 188 can extend a longitudinal axis A-A that is also sloped so as to be generally parallel to the bottom surface of the trough 120, such that the longitudinal axis and the cavity is lower on the first end of the glass forming apparatus than on the second end of the glass forming apparatus. In the embodiment shown in FIG. 9, cavity 188 has an approximately constant height, H, along its longitudinal length.

Alternatively, the amount of material removed by the wire saw may increase or decrease along the longitudinal length of the glass forming apparatus. For example, as shown in FIG. 10, the amount of material removed by the wire saw increases between the first end and the second end such that the cavity has a tapered inner area wherein the area of the cavity 189 is greater at the second end than at the first end such that the cavity has 189 a height, H2, at the second end of the glass forming apparatus that is greater than the height of the cavity, H1, at the first end of the glass forming apparatus. Cavity may also have a width that is greater at one end of the glass forming apparatus than at the other end of the glass forming apparatus. For example, the cavity may have a width that is greater at the second end of the glass forming apparatus than at the first end or vice versa.

By enabling various geometries along the longitudinal length of the glass forming apparatus, more precise temperature control of the glass and glass forming apparatus can be achieved. For example, the temperature of the glass forming apparatus and glass viscosity can be more precisely controlled to have a temperature gradient profile that changes at a predetermined rate in the vertical (or Y-direction, as shown in FIG. 3), such as a temperature that decreases in the downward vertical direction (i.e., the direction from the trough to the wedge-shaped root) and a greater rate than a glass forming apparatus not made in accordance with embodiments disclosed herein. This can enable increased glass flow rate over the weirs of the glass forming apparatus (and, hence, higher glass panel production rates) as well as reduction in the rate of sag of the glass forming apparatus (and, hence, greater useful life of the glass forming apparatus).

Temperature control of the glass forming apparatus can be further enhanced by placing at least one heat transfer facilitation element in the cavity or cavities following application of the wire saw. Heat transfer facilitation element can be any element or component that facilitates heat transfer by any of one or more means of convection, conduction, and radiation. For example, heat transfer facilitation element can include one or more heat flux bayonets that are maintained at a temperature and emissivity to facilitate radiation heat transfer from the glass forming apparatus to the bayonets. Heat flux bayonets can extend along a portion or along the entirety of the longitudinal length of the cavity or cavities While not limited to any particular material, materials for heat flux bayonets can include stainless steels, such as grade 310SS, or superalloys, such as Inconel. In order to maintain the temperature of the heat flux bayonets at a predetermined level, the bayonets can be cooled with a cooling fluid, such as water.

Heat transfer can also be facilitated by flowing at least one fluid through the expanded cavity or cavities made in accordance with embodiments disclosed herein. For example, a fluid at a controlled temperature less than the nominal temperature of the glass forming apparatus can be passed through the cavity or cavities at a controlled flow rate, thereby enhancing convective heat transfer from the glass forming apparatus to the fluid. The fluid can be an inert gas, such as nitrogen, a non-inert gas, such as air provided that if molybdenum is used it is not exposed to the non-inert gas, or a liquid, such as water. Gas or liquid mixtures can also be used if desired. For some applications, a liquid can be more effective than a gas because of its higher heat capacity.

The fluid can be passed through the cavity or cavities in either direction, although in some cases it may be desirable to pass the fluid through the cavity starting at the first or inlet end of the glass forming apparatus since this end, where the molten glass enters the glass forming apparatus, is normally hotter than the glass forming apparatus' second or distal end. If the fluid picks up more heat from the inlet end, it can help smooth out thermal gradients along the glass forming apparatus and thus help control glass flow. Also, having the fluid enter the cavity or cavities on the inlet end can help reduce the temperature of the molten glass at the inlet which may be desirable for certain applications. The fluid can also make multiple passes through the cavity or cavities through the use of a heat exchanger structure.

FIG. 8 illustrates an exemplary embodiment wherein a first set of heat flux bayonets 400 are placed in a first cavity 190 and a second set of heat flux bayonets 402 are placed in a second cavity 192, the bayonets extending along the longitudinal length of the cavities. Insulation 300 and 302 is also placed in the cavities between the heat flux bayonets and the bottom surface of the trough in order to more precisely control the temperature profile and heat transfer characteristics of the glass forming apparatus. At least one heating element (not shown) may also be placed between the insulation and the bottom surface of the trough along the longitudinal length of the cavities. This can allow for fine tuning of the molten glass viscosity flowing in the trough.

In other embodiments, the cavity or cavities may be used to house a structural member comprising a material having a lower creep rate than the material making up the glass forming apparatus. For example, for a zircon glass forming apparatus, the structural member or members can comprise at least one material selected from the group consisting of Al₂O₃, SiN, SiC, molybdenum, and fiber-reinforced structures. In the case of molybdenum rods, the rod is preferably platinum clad or blanketed in an inert atmosphere, e.g., N₂, to reduce oxidation. Materials of these types are capable of demonstrating very low creep even at 1250° C. and thus can provide additional support to a glass forming apparatus composed of zircon or other refractories during operation.

The structural member can be solid and can fully or partially fill the cross-section of the cavity or cavities. In the latter case, the unfilled part of the cavity or cavities can be used for cooling, e.g., by passing a fluid (e.g., liquid or gas) through the unfilled part of the aperture and thus over the exposed surfaces of the structural member and the inner wall of the cavity or cavities.

In further embodiments, the structural member can be hollow and its outer envelope can fully or partially fill the cross-section of the cavity or cavities. In either case, the hollow part of the structural member can be used for cooling, e.g., by passing a fluid through the inside of the structural member. If the outer envelope of the hollow structural member only partially fills the cross-section of the cavity or cavities, the unfilled part of the cavity or cavities can also be used for cooling. The structural member can be contained within the cavity or cavities or can extend beyond the cavity or cavities and engage a support structure on one or, preferably, both of its ends.

Among the benefits provided by embodiments disclosed herein include the ability to continue to use proven materials, such as zircon, in the manufacture of LCD substrates. Such materials are known to be compatible with the glass compositions which have been qualified by display manufacturers. Embodiments disclosed herein also widen the design window for isopipes. For example, isopipes having reduced heights can be produced without impacting sag and thus operating life. This reduces costs both in terms of the isopipe itself and the overall size of the fusion machine. A reduced height can also help reduce the chances of forming secondary crystals, such as those described in commonly-assigned PCT Patent Publication No. 03/055813.

A variety of modifications that do not depart from the scope and spirit of the invention will be evident to persons of ordinary skill in the art from the foregoing disclosure. For example, although the invention has been illustrated in terms of isopipes whose weirs have vertical sides, it is also applicable to isopipes having weirs with sloping sides, e.g., an isopipe having the cross-sectional shape of a V or of a Y with no corner on the outside surface of the pipe at the upper end of the wedge-shaped portion of the pipe. Similarly, although unitary isopipes are shown in FIGS. 2-10, isopipes composed of two or more separate components (which can be composed of the same or different materials) can be used in the practice of the invention. The following claims are intended to cover the specific embodiments set forth herein as well as modifications, variations, and equivalents of these and other types.

What is claimed is:

1. A method for reducing the weight of a glass forming apparatus, the glass forming apparatus comprising:
a trough extending along a longitudinal length of the glass forming apparatus from a first end to a second end, said trough having a bottom surface;
and a first weir and a second weir longitudinally extending along a first and second side of the trough, said first and second weirs having upper surfaces and said first and second weirs converging at a distance away from the trough to form a wedge-shaped root;
wherein the distance between the upper surfaces of the first and second weirs and the bottom surface of the trough decreases between the first end and the second end;
and the method comprising:
forming at least one cavity between the bottom surface of the trough and the wedge-shaped root, said cavity extending along a longitudinal length of the glass forming apparatus from the first end to the second end; and
expanding the size of the cavity by abrasively removing material from the glass forming apparatus through application of a wire saw.

2. The method of claim 1, wherein the wire saw is a continuous loop wire saw

3. The method of claim 1, wherein the wire saw is an oscillating wire saw.

4. The method of claim 1, wherein the step of forming the cavity comprises at least one sub-step selected from the group consisting of drilling a hole along a longitudinal length of the glass forming apparatus from the first end to the second end and forming a hole along a longitudinal length of the glass forming apparatus from the first end to the second end during the initial ceramic blank manufacturing process.

5. The method of claim 1, wherein the motion of the wire saw is controlled by a computer.

6. The method of claim 5, wherein the computer controls the wire saw to remove a predetermined amount of material in the X-direction and in the Y-direction relative to the cavity when viewed from the first end.

7. The method of claim 1, wherein the amount of material removed by the wire saw increases between the first end and the second end such that the area of the cavity is greater at the second end than at the first end.

8. The method of claim 1, wherein cavity extends along a longitudinal axis that is generally parallel to the bottom surface of the trough.

9. The method of claim 1, wherein the method comprises forming at least two cavities between the bottom surface of the trough and the wedge-shaped root, said cavities extending along a longitudinal length of the glass forming apparatus from the first end to the second end; and
expanding the size of the cavities by abrasively removing material from the glass forming apparatus through application of a wire saw.

10. The method of claim 9, wherein a partition is maintained between the cavities following application of the wire saw.

11. The method of claim 1, wherein the wire saw comprises an abrasive material selected from the group consisting of diamond, silicon carbide, boron carbide, zirconium carbide, titanium diboride, titanium carbide, rhenium diboride, and boron nitride.

12. The method of claim 1, wherein the wire saw is cooled with at least one fluid selected from the group consisting of an aqueous based coolant and an oil based coolant.

13. The method of claim 1, wherein the glass forming apparatus comprises zircon.

14. The method of claim 1, wherein the weight of the glass forming apparatus is reduced by at least 15% as a result of the expanding step.

15. The method of claim 1, wherein at least one heat transfer facilitation element is placed in the cavity following application of the wire saw.

16. The method of claim 15, wherein the at least one heat transfer facilitation element comprises application of cooling fluid flow.

17. The method of claim 1, wherein at least one structural member comprising a material having a lower creep rate than the glass forming apparatus material is placed in the cavity following application of the wire saw.

18. The method of claim 15, wherein the at least one heat transfer facilitation element comprises at least one set of heat flux bayonets.

19. The method of claim 18, wherein insulation is placed in the cavity between the set of heat flux bayonets and the bottom surface of the trough.

20. The method of claim 19, wherein at least one heating element is placed in the cavity between the insulation and the bottom surface of the trough.
